(19) United States
(12) Patent Application Publication
(10) Pub. No.: US 2024/0017155 A1
(43) Pub. Date: Jan. 18, 2024

(54) STRATEGIC GAME, GAME SYSTEM AND GAME METHOD

(71) Applicants: Constatine Johannes Korthouwer, Franeker (NL); Dennis Korthouwer, Franeker (NL)

(72) Inventors: Constatine Johannes Korthouwer, Franeker (NL); Dennis Korthouwer, Franeker (NL)

(21) Appl. No.: 18/351,337

(22) Filed: Jul. 12, 2023

Related U.S. Application Data
(60) Provisional application No. 63/368,225, filed on Jul. 12, 2022.

(51) Int. Cl. A63F 3/00; A63F 9/04

(52) U.S. Cl. CPC A63F 3/00261; A63F 3/00697; A63F 9/0415; A63F 2003/00466; A63F 2003/00832

(57) ABSTRACT

A strategic game played on a game board with a plurality of spaces using game piece types having different strengths. Two dice control play and movement of the game pieces about the game board. One six-sided die contains four colors corresponding to the players' game pieces and two jokers. A second six-sided die contains four directions and two jokers. Rolls of the two dice control game piece movements about the game board. When one player's higher strength game piece lands on a same space as another player's lower strength game piece, the lower strength game piece is removed from the game. Various action game board spaces allow (i) pieces to move quickly to a different position on the board, (ii) players secure another turn to roll the dice and (iii) removal of pieces or put into jail. Different strength game pieces can move different distances on the game board.

### CROSS-REFERENCE

This application claims priority to U.S. Patent Application No. 63/368,225 filed Jul. 12, 2022 and which is incorporated herein for all purposes.

### FIELD OF THE INVENTION

The embodiments of the present invention relate to strategic games and, more particularly, to a strategic game played on a gridded board.

### BACKGROUND

Strategic board games (strategy games played on a game board) such as Chess, Checkers, and Stratego®, are not designed for kids. They are complex, time-consuming, and for the majority part strategy based.

In Chess a player predicts an opponent's future movements of chess pieces to plan attacking and defensive positions accordingly. Because the game is 100% strategy, without any random event, typically the more one plays, the better one gets. Consequently, the game is better when played among players with generally the same skill level and not just among random friends. The other drawback of Chess is only 2 players may play making it unsuitable as a family strategy game.

Stratego® (8+) increases the complexity of Chess-like games by adding more pieces, increasing the grid to 10×10, concealing the types of pieces and using a player-determined initial setup. The game of Stratego® involves pieces with different strengths, with each player taking one move per turn. As the playing pieces of two opponents collide, the values of the pieces are compared, and the weaker piece is removed from the game. The strength of a player's piece is hidden from the opponent and only revealed upon collision. The object of Stratego® is to capture the opponent's flag.

To capture the younger (4+) generation, Stratego® developed Stratego® Junior. While over-simplifying the original game of Stratego® and eliminating the original strategy element, the game became unattractive to adults and as such recommended age was limited to 12 years old.

It is the object of the embodiments of the present invention to create a strategic board game for up to 4 players, that can be played without upfront explanation, can be won in less than 30 minutes while capturing the interest of both kids and adults, and where through an element of chance, new players also have an opportunity to win.

### SUMMARY

The embodiments of the present invention involve a game board, game pieces and game instructions. In one embodiment, a square game board depicts a total of sixty-four spaces arranged in an 8×8 matrix. A player die and direction die control game play and movements of game pieces about the game board.

A player may win by eliminating the game pieces of all other players or moving a pre-established game piece from a first pre-established space to a second pre-established space on the game board based on a single pre-established outcome of the roll of the player die and direction die.

Other advantages, objects, variations and embodiments of the present invention will be readily apparent from the following drawings, detailed description, abstract and claims.

### BRIEF DESCRIPTION OF THE DRAWINGS

FIG. 1 illustrates a schematic top-view of the game board without pieces, according to the embodiments of the present invention;

FIG. 2 illustrates a schematic top-view of the game board and pieces for four players wherein the pieces are arranged in the initial pre-determined setup, according to the embodiments of the present invention;

FIG. 3 illustrates the six (6) sides of a unique dice that is used to determine which players' piece(s) should be moved—with the two (2) jokers representing a free choice to move any player's piece(s) (the “Player Dice”), according to the embodiments of the present invention;

FIG. 4 illustrates the six (6) sides of a unique dice that is used to determine in which direction a player's piece(s) should be moved—with the two (2) jokers representing a free choice to move a player's piece in North, East, South, or West direction (the “Direction Dice”), according to the embodiments of the present invention;

FIG. 5 illustrates the boardgame layout in an online environment, according to the embodiments of the present invention; and

FIG. 6 illustrates a flowchart detailing a method of conducting a game according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming machine” or “gaming device” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

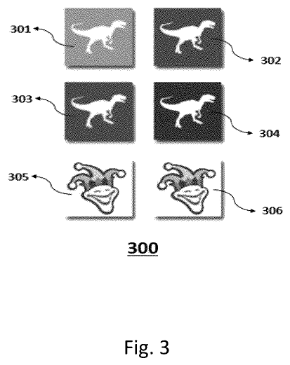

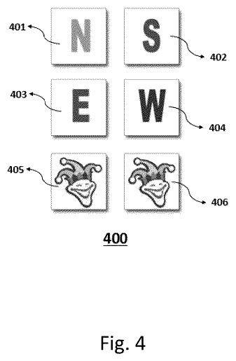

The embodiments of the present invention involve a strategic board game apparatus and method of play with an element of luck, specifically designed for kids. The element of luck or randomness relates to rolling 2 uniquely designed dice 300, 400 shown in FIGS. 3 and 4, respectively. Following the outcome of rolling the dice, a strategic decision needs to be made with respect to which piece(s) to move. Various ‘action spaces’ displayed on the game board 100, such as ‘jail’ or ‘death’, ‘tunnel’, and ‘extra turn’, create excitement. Action spaces may be printed on a physical board game 100, added as moveable elements to a physical board game 100, fixed in a digital (computer program) board game 500, or added as moveable elements (that players can earn) in a digital (computer program) board game 500. The detailed implementation of the inventive elements is believed to produce a greatly improved strategy game that can be played by kids as young as 4 years of age.

In one embodiment, the game incorporates a game board 100 supports up to four players and includes 64 square spaces formed of an 8×8 matrix and six player game pieces comprising six different game piece types of which four are visually distinguishable. While shown as cards, the game pieces may take on any form, shape and dimensions. A first player game piece, as shown, comprises a Tyrannosaurus rex or T-Rex 220-1, 221-1, 222-1 and 223-1, a second player piece, as shown, comprises a Diplodocus 220-2, 221-2, 222-2 and 223-2, a third player piece, as shown, comprises a Ankylosaurus with a hidden star on the underside of the piece 220-3, 221-3, 222-3 and 223-3, a fourth player piece, as shown, comprises a Ankylosaurus 220-4, 221-4, 222-4 and 223-4, a fifth player piece, as shown, comprises a Pteranodon with a hidden star on the underside of the piece 220-5, 221-5, 222-5 and 223-5, and a sixth player piece, as shown, comprises a Pteranodon 220-6, 221-6, 222-6 and 223-6. The Ankylosaurus with hidden star has a higher ranking than the Ankylosaurus without star. The same applies for the Pteranodon with and without star.

While the game shown is dinosaur themed, those skilled in the art will recognize that other characters or symbols may be used to create different themed games according to the same rules and schemes detailed herein.

### The Physical Game Board

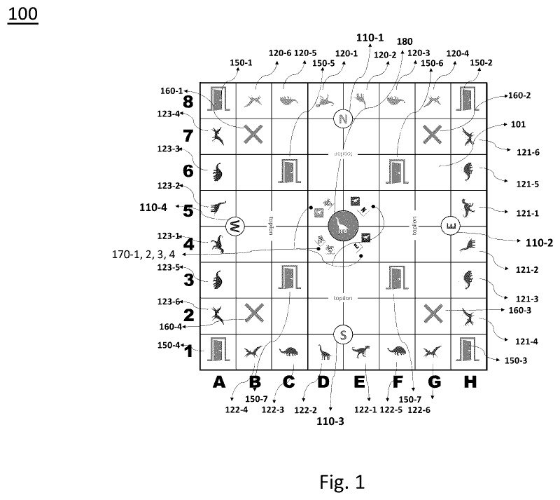

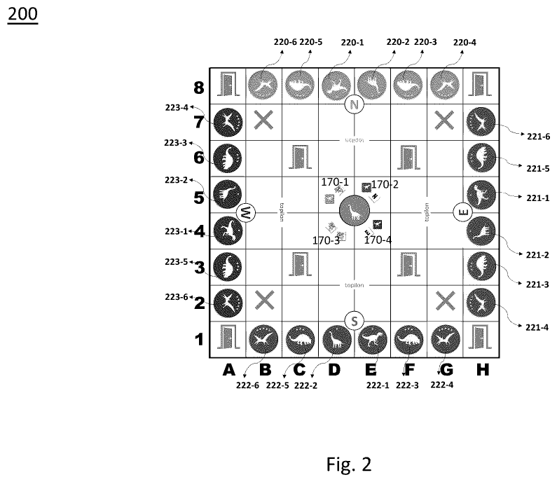

FIGS. 1 and 2 show an exemplary game board 100 comprising a square board with a total of sixty-four spaces 101 arranged in an 8×8 matrix. For notation purposes (e.g., for recording game moves or analysis), the rows are referred to by sequential row numbers from 1 through 8, with row 1 shown in illustrations being across the bottom of the board 100; and the columns are referred to by column letters in alphabetic order using upper case letters from “A” through “H,” with column “A” shown along the left side of the board 100. Thus, the bottom left corner space of the board 100 is referred to as “Space A1.” The four compass directions North (N) 110-1, East (E) 110-2, South (S) 110-3, and West (W) 110-4 are displayed for players to know in which direction a piece should be moved following the outcome of throwing the player dice 300 and the direction dice 400. In one embodiment, the initial setup of player pieces 220-1 through 220-1, 221-2 through 221-6, 222-1 through 222-6 and 223-1 through 223-6 is about the perimeter of the game board 100. Players have the option of which spaces to initially place the Ankylosaurus and Pteranodon pieces with and without the hidden star. In addition, there are ‘action spaces’ 150-1 through 150-8, 160-1 through 160-4 and 170-1 through 170-4 and a ‘Topilon® space’ 180.

When a player moves a player piece 220-1 through 220-6, 221-1 through 221-6, 222-1 through 222-6 and 223-1 through 223-6 onto an action space 150-1 through 150-8, known as a secret door or tunnel space, said player piece must be moved to another secret door or tunnel 150-1 through 150-8 on the game board 100. If the new tunnel space is occupied by one or more pieces from another player, the highest ranked piece(s) remain on the game board 100. In case of equal strength, multiple pieces remain on such space.

When a player moves a player piece 220-1 through 220-6, 221-1 through 221-6, 222-1 through 222-6 and 223-1 through 223-6 onto the action space 160-1 through 160-4, known as cross or death spaces, said piece is eliminated from the game or alternatively placed in jail. When a player moves a player piece onto the action space 170-1 through 170-4, known as dice spaces, the player may throw the dice again.

A player wins the game by (a) eliminating or putting in jail all other players' pieces or (b) throwing a joker 305, 306 on the 6-sided player die 300 shown in FIG. 3 and a joker 405 or 406 on the direction die 400 shown in FIG. 4 when the player's Diplodocus piece 120-2, 121-2, 122-2 or 123-2 on a dice space 170-1 through 170-4 (i.e., one of spaces D4, D5, E4, or E5).

### The Digital Game Board

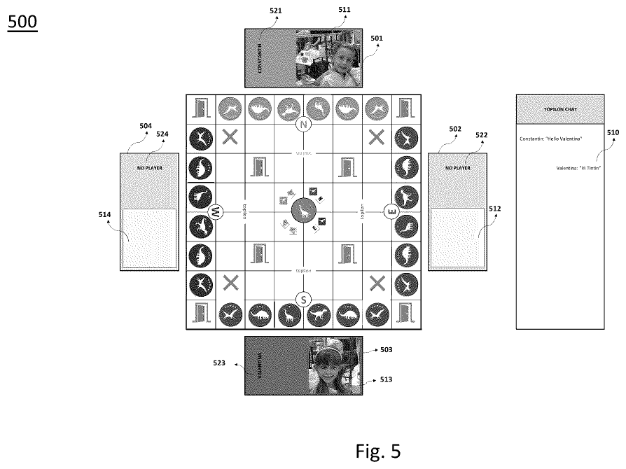

FIG. 5 shows the game board in an online environment through a computer program product. To increase the physical connection between kids, the online game board 500 includes a chat section 510 and a player's profile section 501, 502, 503 and 504.

The player's profile section 501, 502, 503 and 504 may contain player information such as (i) a photo or live video stream from of the player 511, 512, 513 or 514, (ii) the player's name and/or nickname 521, 522, 523 or 524 and/or (iii) game play data such as number of games played, player rating, player ranking, etc. In one embodiment, player profile sections 501, 502, 503 or 504 not having an active player, are marked with a different color or otherwise highlighted.

The computer embodiment of the game can have a multitude of new and exciting features that will further enhance the game play experience for kids. One of the benefits of the computer embodiment is that the game can be played by a single player against the computer allowing players to enhance their game-play skills. Another benefit is that the action spaces 150, 160, and 170 can easily find new fixed locations on the game board 500 or be moved/added by players during the game—for example, when throwing 2 jokers 305, 306 and 405, 406 a player be provided the opportunity to change the game board layout by moving or adding a tunnel/door space.

### Game Pieces

FIG. 2 shows one embodiment of a game board 100 with players' game pieces 220-1 through 220-6, 221-1 through 221-6, 222-1 through 222-6 and 223-1 and 223-6 are placed on the pre-determined spaces. For the sake of simplicity, each of the directions 110-1 through 110-4 has its own color. In one embodiment, North 110-1 is orange, East 110-2 is red, South 110-3 is Green and West 110-4 is blue. The direction colors correspond to the four colors on the four sides 301-304 of the player dice 300 and the four sides 401-404 of the direction dice 400.

Each player begins play with six game pieces 220-1 through 220-6, 221-1 through 221-6, 222-1 through 222-6 and 223-1 and 223-6 comprising six different game piece types, as described above, wherein four are visually distinguishable. The different game piece types and associated strengths (“Strength”), maximum number of steps in one direction (“Steps”), and qualities (“Qualities”) in Table 1 below.

TABLE 1

| Piece type | Strength | Steps | Qualities |
|---|---|---|---|
| T-Rex | 1 | 1 | Can free pieces from jail (if |
| 220-1, 221-1, | | | applicable) |
| 222-1, 223-1 | | | |
| Diplodocus | 2 | 1 | Wins the game if placed on the |
| 220-2, 221-2, | | | center circle - Topilon ® space 180 |
| 222-2, 223-2 | | | |
| Ankylosaurus * | 3 | 3 | “*” is hidden on an underside of |
| 220-3, 221-3, | | | the game piece. This player wins |
| 222-3, 223-3 | | | against an Ankylosaurus game |
| | | | piece without the “*” |
| Ankylosaurus | 4 | 3 | |
| 220-4, 221-4, | | | |
| 222-4, 223-4 | | | |
| Pteranodon * | 5 | 5 | “*” is hidden on an underside of |
| 220-5, 221-5, | | | the game piece. This player wins |
| 222-5, 223-5 | | | against a Pteranodon game piece |
| | | | without the “*” |
| Pteranodon | 6 | 5 | |
| 220-6, 221-6, | | | |
| 222-6, 223-6 | | | |

The Strength of the game piece type is measured by a number from 1 (strongest) to 6 (weakest). Under different game rules and embodiments, the Strength and number of Steps for each of the game piece types may vary.

On the initial setup of the game, a player may place its “Ankylosaurus *” on either of the two Ankylosaurus spaces (two second most outer spaces) and may place its “Pteranodon *” piece on any of the two Pteranodon spaces (e.g., two most outer spaces).

In one embodiment, a player may stack multiple game pieces on top of each other and move them collectively to another space. A player with more collective game pieces attacking a player with less game pieces always wins. If the number of game pieces is equal, the Strength of the combined number of game pieces for each player is compared with the lower numerical Strength winning (i.e., the lower the Strength number of a game piece, the greater the Strength, which also applies to the aggregate Strength of multiple game pieces).

A player with multiple game pieces stacked on one space, may choose to either move the top game piece or all game pieces collectively during one move. Alternatively, a player may move any number of stacked game pieces collectively during one move. In one embodiment, a player may only take game pieces from the top. For example, if 3 game pieces are stacked, the player may move the top game piece, the top two game pieces or all three game pieces. The number of spaces that the one or more game pieces can be moved is dictated by the top piece. In other words, if the middle game piece or bottom game piece can be moved 5 spaces and the top game piece can be moved only 1 space, then all game pieces moved can only be moved 1 space.

If a player rolls a joker on the direction die 400 and a color on the player die 300, the roller moves a correspondingly colored game piece in any desired direction based on the number of steps associated with the game piece. If the player rolls a joker on the player die 300 and a direction on the direction die 400, the player can select which color game piece to move. If a player rolls two jokers, the player may move any game piece in any direction, including diagonal (to enter the middle section of the board game) and thus win the game.

### Game Play

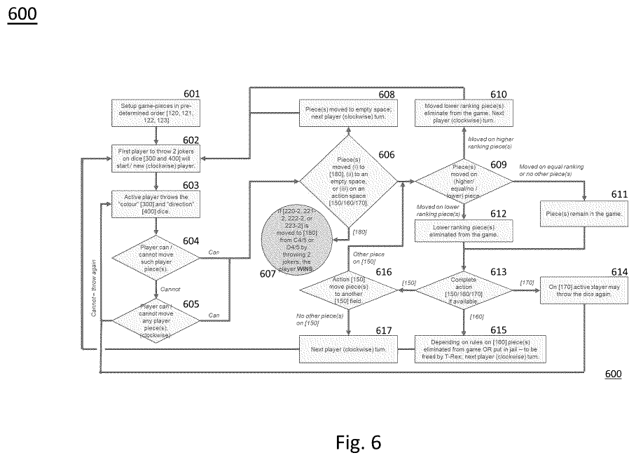

FIG. 6 shows a flowchart 600 detailing how, in one embodiment, the game is conducted. The game is turn-based with up to four players, each playing with a different color related to one of the directions 110-1, 110-2, 110-, and 110-4. At 601, each player places its colored game pieces 220-1 through 220-6, 221-1 through 221-6, 222-1 through 222-6 and 223-1 through 223-6 on their pre-established positions. The positions may be on a physical game board 100 or a virtual game board 500 having a player interface. When all players have positioned their game pieces 220-1 through 220-6, 221-1 through 221-6, 222-1 through 222-6 and 223-1 through 223-6, at 602, the player having first rolled two jokers 305 or 306 and 405 or 406 (Starting Player) begins the game. The roll of dice may be of physical dice or virtual dice. At 603, the Starting Player rolls the two dice 300 and 400. At 604, it is determined if the player cannot move any one game piece commensurate with the roll of the dice, for example, if the dice color does not match the player's game piece color or if the player's game piece cannot be moved in the required direction, it is determined at 605, if a next (clockwise) player's game piece can be moved. If so, that player's game piece is moved by the roller accordingly. By way of example, if a player playing red game pieces rolls Green+North, the roller moves a green game piece of the player playing the green game pieces. In one embodiment, only the roller moves game pieces. If none of the player's game pieces can be moved, at 603, the Starting Player rolls the dice again.

At 606, moving game piece(s) can result in three possible outcomes, namely (i) game piece 220-2, 221-2, 222-2 or 223-2 is moved from space C4, C5, D4 D5 onto the Topilon® space 180 of the game board 100 or 500 by rolling 2 jokers 305, 306 and 405, 406, in which case, at 607, the player wins the game; (ii) a game piece 220-1 through 220-6, 221-1 through 221-6, 222-1 through 222-6 and 223-1 through 223-6 is moved onto an empty space, in which case, at 608, nothing happens, and the dice pass to the next player (clockwise) to throw the dice; or (iii) a game piece 220-1 through 220-6, 221-1 through 221-6, 222-1 through 222-6 and 223-1 through 223-6 is moved onto a space occupied by no other game pieces or, at 609, one or more other players' game pieces (a space may only be occupied by multiple players' game pieces if they have an equal Strength). If, at 609, one or more other player's game pieces are present, there are three possible outcomes, namely (i) at 610, lower ranking player's game piece(s) moved onto higher ranking player's game piece(s) 220-1 through 220-6, 221-1 through 221-6, 222-1 through 222-6 and 223-1 through 223-6 with the lower ranking game piece(s) 220-1 through 220-6, 221-1 through 221-6, 222-1 through 222-6 and 223-1 through 223-6 being eliminated from the game and the next player (clockwise) becoming the active roller; (ii) at 611, game piece(s) 220-1 through 220-6, 221-1 through 221-6, 222-1 through 222-6 and 223-1 through 223-6 moved onto equally ranked game piece(s) 220-1 through 220-6, 221-1 through 221-6, 222-1 through 222-6 and 223-1 through 223-6 with all game pieces remaining on the space and in the game; or (iii) at 612, higher ranking player's game piece(s) 220-1 through 220-6, 221-1 through 221-6, 222-1 through 222-6 and 223-1 through 223-6 moved onto lower ranking game piece(s) 220-1 through 220-6, 221-1 through 221-6, 222-1 through 222-6 and 223-1 through 223-6 with the lower ranking player's game piece(s) 220-1 through 220-6, 221-1 through 221-6, 222-1 through 222-6 and 223-1 through 223-6 being eliminated from the game.

Subsequently, if, at 611 or 612, a player's game piece(s) 220-1 through 220-6, 221-1 through 221-6, 222-1 through 222-6 and 223-1 through 223-6 remain(s) on the space, at 613, it is determined if the space occupied is an action space. Moving onto an action space initiates a certain pre-established action to be taken by the player moving one or more game pieces onto such action space. In one embodiment, three types of action spaces 150-1 through 150-8, 160-1 through 160-4 and 170-1 through 170-4 are available. When action space are landed on, possible outcomes comprise: (i) at 616, a tunnel space 150-1 through 150-8 where a player must move the game piece(s) to another tunnel space 150-1 through 150-8 on the game board if occupied, at 609, it is determined if any game piece(s) is or are removed and the dice pass to the next player; (ii) at 615, a death or cross space 160-1 through 160-4 with all player's game piece(s) being eliminated from the game and the dice pass to the next player; or (iii) at 614, a dice space 170-1 through 170-4 with the active player rolling the dice again. In an alternative embodiment, the death or cross space is replaced with a jail space where the player's game piece(s) remain until freed by the same player's T-Rex 220-1, 221-1, 222-1 or 223-1 game piece. Upon moving a T-Rex onto such jail field or space, both the T-Rex and the player's jailed piece(s) are moved to the space on which the T-Rex was positioned prior to the dice roll.

### Winning Game Play

The game according to the embodiments of the present invention may be won in one of two ways. First, the Diplodocus game piece 220-2, 221-2, 222-2 or 223-2 is moved from position D4, D5, E4, or E5 onto the Topilon® space 180 and the player rolls two jokers 305, 306 and 405, 406. Second, a player wins when all other players have no game pieces remaining. With the jail embodiment, jailed game pieces are deemed no longer in play.

Although the invention has been described in detail with reference to several embodiments, additional variations and modifications exist within the scope and spirit of the invention as described and defined in the following claims.

We claim:

1. A method comprising:
utilizing a game board game formed of a plurality of game board spaces, said game board including directional indicia;
utilizing a plurality of game pieces for each of four players;
establishing strengths and a number of steps for each game piece;
utilizing a pair of six-sided dice comprising a first die depicting four player colors and two jokers and a second die depicting four directions and two jokers; and
instructing players to move said game pieces according to rolls of said pair of dice until one player wins by rolling a pre-established outcome while on one or more of said pre-established plurality of said game spaces or being a final player with game pieces remaining.

2. The method of claim 1 further comprising identifying certain of said game board spaces as action spaces comprising one or more of tunnel spaces, death spaces, jail spaces and/or dice spaces.

3. The method of claim 1 further comprising utilizing six game pieces for each player.

4. The method of claim 1 wherein said second die depicts directions of North, South, East and West corresponding to directions depicted on said game board.

5. The method of claim 1 further comprising comparing strengths of game pieces for individual players when said game pieces land on the same board game space and removing from play game pieces associated with a lesser strength.

6. The method claim 1 further comprising:
(i) responsive to a player rolling a joker on the direction die and a color on the player die, allowing the roller to move a correspondingly colored game piece in any desired direction based on a number of steps associated with the game piece; and/or
(ii) responsive to a player rolling a joker on the player die and a direction on the direction die, allowing the player to select which color game piece to move.

7. A computer-implemented method comprising:
utilizing a processor running executable instructions;
utilizing a virtual game board game formed of a plurality of virtual game board spaces, said game board including directional indicia;
utilizing a plurality of virtual game pieces for each of four players;
establishing and storing in memory strengths and a number of steps for each virtual game piece;
utilizing a pair of six-sided dice comprising a first die depicting four player colors and two jokers, a second die depicting four directions and two jokers; and
via user interface, allowing players to move said virtual game pieces according to virtual rolls of said pair of virtual dice until one player wins a game by rolling a pre-established outcome while on one or more of said pre-established plurality of said virtual game spaces or being a final player with virtual game pieces remaining.

8. The computer-implemented method of claim 7 further comprising identifying certain of said virtual game board spaces as action spaces comprising one or more of tunnel spaces, death spaces, jail spaces and/or dice spaces.

9. The computer-implemented method of claim 7 further comprising utilizing six virtual game pieces for each player.

10. The computer-implemented method of claim 7 wherein said virtual second die depicts directions of North, South, East and West corresponding to directions depicted on said virtual game board.

11. The computer-implemented method of claim 7 further comprising utilizing said processor to compare strengths of virtual game pieces for individual players when said virtual game pieces land on the same virtual board game space and removing from play virtual game pieces associated with a lesser strength.

12. The method claim 7 further comprising:
(i) responsive to a player rolling a joker on the virtual direction die and a color on the virtual player die, allowing the roller to move a correspondingly colored virtual game piece in any desired direction based on a number of steps associated with the virtual game piece; and/or
(ii) responsive to a player rolling a joker on the virtual player die and a direction on the virtual direction die, allowing the player to select which color game piece to move.

13. A system comprising:
a game board game formed of a plurality of game board spaces, said game board including directional indicia;
a plurality of game pieces for each of four players, said plurality of game pieces having associated strengths and a number of steps;
a pair of six-sided dice comprising a first die depicting four player colors and two jokers and a second die depicting four directions and two jokers; and
wherein said game pieces are moved according to rolls of said pair of dice until one player wins by rolling a pre-established outcome while on one or more of said pre-established plurality of said game spaces or being a final player with game pieces remaining.

14. The system of claim 13 wherein certain of said game board spaces are action spaces comprising one or more of tunnel spaces, death spaces, jail spaces and/or dice spaces.

15. The system of claim 13 wherein said game board is an 8×8 matrix of game board spaces.

16. The system of claim 13 further comprising six game pieces for each player.

17. The system of claim 13 wherein said second die depicts directions of North, South, East and West corresponding to directions depicted on said game board.

18. The system of claim 13 wherein strengths of game pieces determine which game pieces are removed from game play.

19. A computer-implemented system comprising:
a processor running executable instructions;
a virtual game board game formed of a plurality of virtual game board spaces, said game board including directional indicia;
a plurality of virtual game pieces for each of four players;
strengths and a number of steps for each virtual game piece stored in memory;
a pair of six-sided dice comprising a first die depicting four player colors and two jokers and a second die depicting four directions and two jokers; and
wherein, via a user interface, players move said virtual game pieces according to virtual rolls of said pair of virtual dice until one player wins a game by rolling a pre-established outcome while on one or more of said pre-established plurality of said virtual game spaces or being a final player with virtual game pieces remaining.

20. The computer-implemented system of claim 19 wherein certain of said virtual game board spaces are action spaces comprising one or more of tunnel spaces, death spaces, jail spaces and/or dice spaces.

21. The computer-implemented system of claim 19 wherein said virtual game board is formed of an 8×8 matrix of virtual game board spaces.

22. The computer-implemented system of claim 19 further comprising six virtual game pieces for each player.

23. The computer-implemented system of claim 19 wherein said virtual second die depicts directions of North, South, East and West corresponding to directions depicted on said virtual game board.

24. The computer-implemented system of claim 19 wherein said processor is configured to compare strengths of virtual game pieces for individual players when said virtual game pieces land on the same virtual board game space and remove from play virtual game pieces associated with a lesser strength.
